(19) United States
(12) Patent Application Publication
(10) Pub. No.: US 2009/0317625 A1
(43) Pub. Date: Dec. 24, 2009

(54) WEAR-RESISTANT COATING

(75) Inventors: Dirk Richter, Dueren (DE); Christian Pluta, Moenchengladbach (DE)

Correspondence Address: COLLARD & ROE, P.C., 1077 NORTHERN BOULEVARD, ROSLYN, NY, 11576, US

(73) Assignee: DIRK RICHTER, DUEREN (DE)

(21) Appl. No.: 12/311,816

(22) PCT Filed: Oct. 15, 2007
(86) PCT No.: PCT/DE2007/001810

§ 371 Date: Jun. 18, 2009

(30) Foreign Application Priority Data
Oct. 13, 2006 (DE) 10 2006 049 062.2

(51) Int. Cl. B32B 5/16

(52) U.S. Cl. 428/328; 428/323

(57) ABSTRACT

Disclosed is a wear-resistant coating composed of hard particles in a plastic matrix. At least 10 percent by volume of the hard particles are hard balls or have an index of roundness exceeding 0.05 or a surface roughness of less than 15 percent.

The invention relates to a wear-resistant coating, in particular for rollers.

Such wear-resistant coatings can be composed in a large variety of ways. Thus, they may be composed purely ceramically for example, as is disclosed inter alia in DE 698 09 992 T2. Here, the ceramic can be applied for example by means of thermo-spraying, high-speed flame spraying or plasma spraying. However, composite materials composed of hard particles, e.g. silicon carbide grains, in a plastic matrix, are simpler to apply, as are described for example in DE 102 47 280 A1, DE 42 26 789 A1 or JP 60-197 770 A.

It is an object of the present invention to develop wear-resistant coating of hard particles in a plastic matrix so as to be more durable.

As a solution, the invention suggests on the one hand a wear-resistant coating of hard particles in a plastic matrix, which is distinguished in that at least 10% by vol. of the hard particles are hard balls.

In this way, a coating is already provided with a relatively small proportion of hard balls, in which the hard balls are embedded more uniformly all around into the plastic matrix than is the case in the known wear-resistant coatings, so that these hard balls embed in a more stable manner in the plastic matrix and the coating keeps for longer, even if possibly some angular grains can be lost from the coating in the case of lengthy use. However, it has been found that even this small proportion already ensures an excellent improvement in stability. This applies in particular also in distinction to the wear-resistant coatings represented in DE 102 47 280 A1, in DE 42 26 789 A1 or in JP 60-197 770 A, wherein in these publications a differentiation is not made between hard balls on the one hand and hard particles on the other hand.

Here, wear-resistant coatings are to be differentiated in particular from decorative films, as are disclosed for example in DE 195 08 797 C1, DE 100 61 497 B4, DE 196 04 907 A1, WO 97/00172 A1, U.S. Pat. No. 3,928,706 or EP 0 519 242 A1. Whereas decorative films per se consist of relatively low-viscosity, wear-resistant lacquers, which are applied in a very thin layer onto a paper web and if applicable are interspersed with hard particles, so that the lacquers per se constitute the product as such, i.e. the decorative film, the wear-resistant coatings according to the invention are applied subsequently onto a product and accordingly only influence the surface characteristics of the product which is provided with a corresponding wear-resistant coating. Here, in the case of decorative films, in particular the translucent character of the decorative film is in the forefront, so that the density of hard particles is selected to be very low, especially since the corresponding decorative films, unlike the wear-resistant coatings according to the invention, are generally not subject to long-term stress, but rather are only stressed occasionally, for example in the case of a blow or a step.

By an increase of the proportion of hard balls, the risk of a loss of hard particles can be limited to the necessary extent, so that the proportion of hard balls can preferably be 30% by vol., 70% by vol. or even 90% by vol.

Also in particular with proportions of hard balls lying over 10% by vol., it is assumed that in the case of wear of the plastic matrix, fewer hard material edges are exposed, so that a stressing of materials which come in contact with the surface which is coated in this way can be reduced to a minimum.

In the present context, it is necessary to differentiate between hard balls and other hard grains. As also in the case of hard balls, the concern is with particles which are produced industrially in an extremely large number, these naturally show deviations from an ideal ball. Such deviations can also be rendered intrinsically to the hard balls in particular through the production method, for example when the hard balls are obtained by cooling from a liquid phase sprayed as droplets. Sintering methods, spraying methods or melting methods are used in particular as production methods.

For the characterizing of hard particles as hard balls, the deviation of the particle surface to a ball or to an ellipsoid can serve as a gauge. Here, preferably one works in cross-sections through the hard particles, so that in these cross-sections the deviation of the surface of a particle from a circle or an ellipse serves to characterize a particle as a ball. Preferably, the circle or the ellipse is determined from the section surface of the particle by means of a “best fit” method. This can take place for example iteratively or else by statistical methods, such as a fitting of a circle or an ellipse to the section surface of the particle. In this context, ellipses or ellipsoids, the semiaxes of which lie below a length ratio of one to 10, will still be regarded as circles or balls in the sense of the invention.

Hard particles are then designated as hard balls in the present sense, when the relative depth of roughness is below 0.1 or when the variance divided by the particle area is greater than 0.01. The particles are then sufficiently round in order to be able to constitute the corresponding advantages. It is to be understood here that this information relates to the respective mean values, because in such a coating a multiplicity of hard particles is to be found.

Accordingly, a wear-resistant coating of hard particles in a plastic matrix is also proposed as a solution, which is distinguished in that at least 10% by vol. of the hard particles have a roundness index greater than 0.05, preferably greater than 0.1, in particular greater than 0.15. Here, the roundness index is preferably defined as a difference in diameter of two concentric circles, between which the circumferential line of the respective particle lies, it being understood that here also, in view of the multiplicity of particles in the coating, only mean values play a part.

Preferably the proportion of hard particles lies over 15% by vol., 20% by vol. or even 30% by vol., wherein it is understood that via the roundness index ellipsoid particles can be detected to a sufficient extent with difficulty, although the corresponding advantages can be connected therewith.

Likewise accordingly, a wear-resistant coating of hard particles in a plastic matrix is proposed as a solution, which is distinguished in that at least 10% by vol. of the hard particles have a surface roughness less than 15%, preferably less than 12%, in particular less than 10% of the mean particle diameter.

Hereby, also, the advantages according to the invention can be directly achieved, wherein the proportion of corresponding hard particles here can also preferably be over 30% by vol. or 70% by vol. or even 90% by vol.

Various measurement methods can serve to determine the roughness, without deviating from the present invention. Thus, in approximation to the averaged depth of roughness R_{z} the cross-section is divided into 10 angle segments and for each segment in a linear averaging the maximum distance to a straight line averaged from the surface line in the respective segment is calculated and from these ten values the mean value is formed. Instead of this roughness R_{zk}, however, the roughness can also be determined in particular in relation to the centre of area of the respective particle in the section view, according to the average roughness Rₐ.

On the other hand, as a solution a wear-resistant coating of hard particles in a plastic matrix is proposed, which is distinguished in that the proportion of hard particles in the plastic matrix is over 40% by weight.

According to the actual development, the hard particle proportion can be over 45% by weight or over 50% by weight, whereby the wear-resistant coating can be surprisingly developed to be more durable, although the proportion of plastic matrix which per se gives the composite its durability, becomes less. For this reason, it can be particularly advantageous when the proportion of hard particles in the plastic matrix is below 95% by weight, preferably below 90% by weight.

Likewise, as a solution a wear-resistant coating of hard particles in a plastic matrix is proposed, which is distinguished in that the proportion of hard particles in the plastic matrix is over 15% by vol., preferably over 20% by vol. or over 25% by vol. Accordingly, it is advantageous in a particular development, when the proportion of hard particles in the plastic matrix is below 80% by vol., preferably below 70% by vol.

It has been surprisingly found here that such high particle densities can be achieved in particular in cooperation with hard balls. This applies in particular also when relatively poorly pourable starting materials are used for the plastic matrix, which through the presence of a plurality of hard grains according to the prior art can no longer be applied to a wear-resistant coating.

Here, in particular, the bulk density index of the hard particles can be over 0.54, preferably 0.56 or greater. Such bulk density indices represent a measurement for the capability of the hard particles not to impede each other reciprocally in a flow process and therefore to make possible extremely high hard particle concentrations, without reducing too greatly an ease of brushing of the plastic matrix. Here, the bulk density index can be determined on the one hand from the starting materials which are measured accordingly in their bulk density and are then normalized to the density of the hard particles. Likewise, the hard particles can also be subsequently removed from the coating, cleaned, dried accordingly and then measured in such a way. Furthermore, it is to be understood that such a bulk density index is also advantageous independently of the other advantages of the present invention for a wear-resistant coating of hard particles in a plastic matrix.

Preferably, the dust proportion of hard particles amounts to 10% by weight of the hard particles, wherein the dust proportion in the present context is defined as the proportion of particles with a diameter smaller than 0.1 μm. Through natural wear during manufacture and through other circumstances, the dust proportion can be almost eliminated to zero, which, however, would per se accordingly most advantageously lead to a durable wear-resistant coating, in particular since the dust component only contributes very little to the increase of durability.

It is also advantageous accordingly, if at least 10% by weight of the hard particles have a diameter greater than 1 μm. Such a measure also contributes to an increase in the overall stability of the wear-resistant coating.

Preferably, the volume proportion of the hard particles perpendicularly to the surface of the wear-resistant coating varies less than 20%, in particular by less than 10%. Hereby, the wear-resistant coating in the case of wear can be abraded several times, before it finally has to be renewed, without the characteristics of the surface changing considerably, because the wear-resistant coating is then constructed extremely homogeneously in its depth. In particular, such a regrinding can be carried out in a substantially more favourably priced manner and more quickly than the application of a new coating.

Accordingly, it is cumulatively or alternatively advantageous when the thickness of the layer is at least four times as great as the mean grain diameter of the hard particles. A regrinding several times can also be made possible hereby.

The present invention is suitable in particular for wear-resistant coatings with a layer thickness of over 0.8 mm, preferably of over 1.0 mm or even of over 1.2 mm. Accordingly, such wear-resistant coatings according to the invention are also particularly suitable for relatively large objects, such as for example rollers in paper manufacture or other large rollers, with surfaces to be coated of more than 1 m². It can be immediately seen that in the case of the coating of rollers which are 4 m or more long, and have diameters of over 30 cm, manufacturing techniques and material qualities from precision engineering, such as are to be found for example in printer- and copier rollers, can not be used. The extraordinary stability of the wear-resistant coatings according to the invention principally makes their use possible in machine construction, in particular also in heavy machine and plant construction.

It is to be understood that the homogeneous construction and the thickness of the wear-resistant coating also opens up the possibility of regrinding several times, independently of the other features of the present invention in a wear-resistant coating of hard particles in a plastic matrix.

It is to be stressed in particular here that the wear-resistant coating according to the invention, in particular deviating from DE 103 01 135 A1, DE 35 03 859 C2, U.S. Pat. No. 5,389,299 and U.S. Pat. No. 5,674,631 and U.S. Pat. No. 3,617,363 does not have a metallic matrix, but rather uses plastic as a matrix, into which hard materials, which if applicable may also have metallic components, are embedded. In particular, if applicable also further materials, such as for example sliding- or anti-adhesion materials, e.g. polytetrafluoroethylene, can be embedded into the matrix.

Preferably, the hard particles have a screen sizing less than 600 μm with a substantially Gaussian distribution. Hereby, a good mixture of plastic matrix and hard particles can be ensured, which supports a sufficient number of hard particles sufficiently elastically in the plastic matrix. Here, strictly speaking, no Gaussian distribution is present, because this is cut off at the top by the establishing of a screen sizing. It is also advantageous to provide bimodal or higher modal distributions, because hereby higher packing densities can be achieved. Thus, for example, 5 μm and 50 μm particles are mixed respectively in a particular distribution, preferably in a Gaussian distribution, so that a complex overall distribution is produced.

Preferably the screen sizing lies below 150 μm, wherein in particular hereby a relatively benign coating can be realized which, in particular also after an abrasion, has a very small roughness, wherein the assumption exists that through such a screen sizing the hard particles can protect the matrix better from corroding or abrasive attacks. It has been found here that with less round hard particles, lower screen sizings, for example also below 125 μm, are advantageous.

The hard particles accordingly preferably have an average particle diameter less than 500 μm, preferably less than 120 μm or less than 100 μm or even less than 90 μm or 80 μm, so that a fine distribution of the hard particles can be ensured. In particular, with a proportion of over 40 or more % by weight or over 15 or more % by vol., in this way a coating can be provided with completely new, in particular very low-wear, material-protecting characteristics. Prepared in a sufficient thickness, this coating can also be readily re-ground several times, without considerably altering its characteristics.

In actual embodiments, wear-resistant coatings with a screen sizing of 25 μm in hard particles with points or of 23 μm in hard balls have proved to be relatively benign with regard to a web running thereon, for example made of paper, and are nevertheless extremely low-wear.

The hard particles can comprise in particular hard metal particles or balls or steel particles or balls. Whereas steel particles can be produced very well as balls in almost every size distribution, the advantages described above are produced in particular. However, also in the case of hard metal particles which generally have very sharp edges, the wear-resistant coating can be constructed by the invention described above in a surprisingly stable manner, if at least some of the particles do not have such sharp edges.

Preferably, the hard particles have a Mohs hardness over 4, preferably over 5. Hard particles of such hardness lead in particular to an excellent stabilizing of the plastic matrix. Also in such a development the plastic matrix can be constructed so as to be relatively hard, without the advantages of a substantially higher elasticity of the plastic matrix with respect to the hard particles being lost.

On the other hand, also softer hard particles can be used, in particular if also the plastic matrix in itself is selected to be softer. Thus, it can be advantageous if the plastic matrix has a Shore D hardness below 80. In such a development, the hard particles should then have a Shore D hardness which lies over the Shore D hardness of the plastic matrix, so that these stabilize the wear-resistant coating sufficiently.

Here, it is particularly to be taken into account that particles or surfaces generally are only accessibly either to a hardness measurement according to Mohs or a hardness measurement according to Shore. In the case of relatively very hard particles, a measurement according to Shore provides no more significant results. If the particles are not entirely very hard, then by means of a measurement according to Mohs, no more differentiation can be made, so that then measurements according to Shore must be carried out.

The present invention is also to be differentiated from wear-resistant coatings in which solid materials are integrated chemically into a matrix, as is disclosed for example in DE 37 25 742 A1 by means of hard rubber particles which are embedded in a rubber matrix. In this respect it is advantageous if the plastic matrix lies at least one, preferably two, degrees of hardness according to Mohs or at least 10, preferably 20, degrees of hardness according to Shore D below those of the hard particles, so that the advantages of the inherent elasticity of the plastic matrix on the one hand and the stabilizing effect of the hard particles on the other hand can be converted in cumulating manner.

Preferably a duroplastic plastic matrix is used as plastic matrix. In the present context, the term “duroplastic plastic matrix” designates a plastic matrix which merely through destruction can be liquefied again or removed. Plastomers or thermoplasts are to be differentiated in particular herefrom. The plastic matrix may comprise here for example polyurethanes, polyureas and/or epoxides or cross-linked technical rubbers.

In the drawings

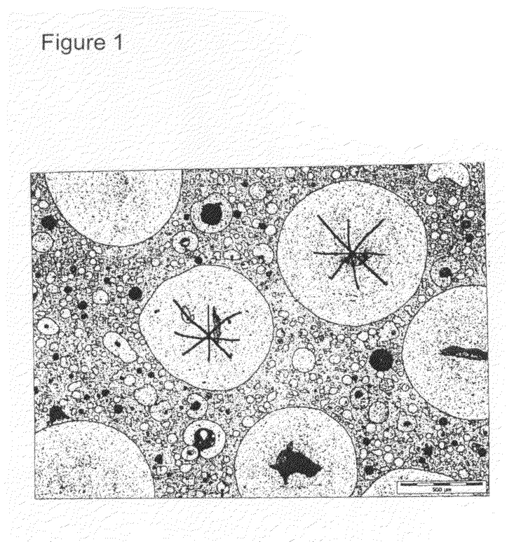

FIG. 1 shows a wear-resistant coating according to the invention, in section;

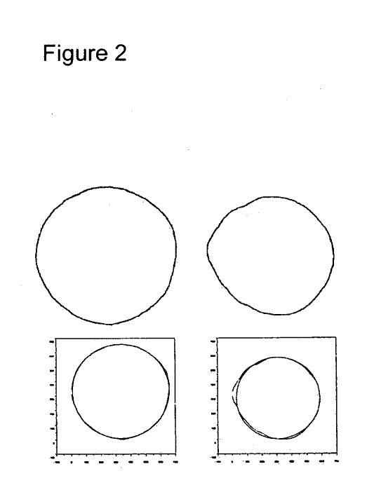

FIG. 2 shows graphic processings of two hard particles of FIG. 2;

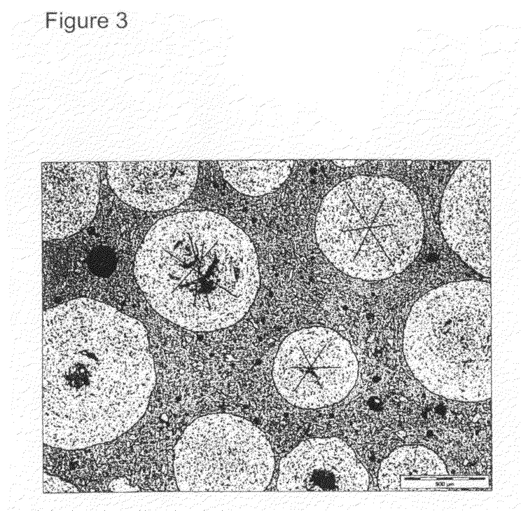

FIGS. 3 to 5 show further wear-resistant coating according to the invention; and

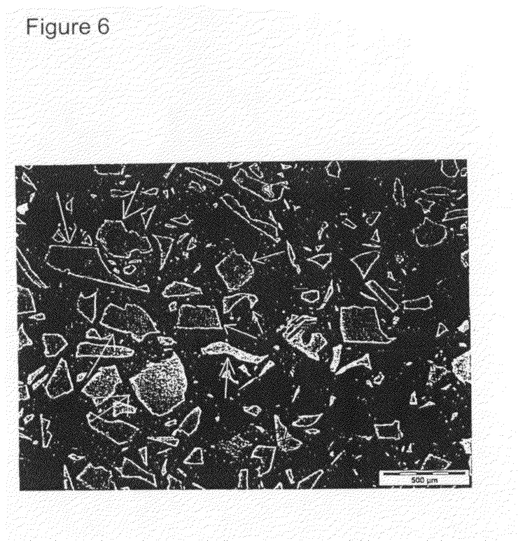

FIG. 6 shows a wear-resistant coating according to the prior art.

As can be seen directly from a comparison of FIGS. 1 and 3 to 6, in which respectively wear-resistant coatings of hard particles in a plastic matrix are illustrated in microscopic cross-sections, the wear-resistant coatings according to the invention, illustrated in FIGS. 1 and 3 to 5 have substantially rounder hard particles than the wear-resistant coating according to the prior art.

Here, a majority of the hard particles can be designated as hard balls accordingly in view of this roundness. In order to be able to make a differentiation in accordance with the definition given here that hard particles are designated as hard balls in the present sense when the relative depth of roughness of the surface is below 0.1 or when the variance of the surface divided by particle area is greater than 0.01, in this measurement example the hard particles are firstly detected graphically, as taking place with the aid of the example embodiment according to FIG. 1 in the upper region of FIG. 2 for the hard particles marked in FIG. 2 with a cross. A best possible circle is then adapted to the graphic detection, as illustrated in the lower region of FIG. 2.

In the present measurement example of FIGS. 1 and 2, the circle was respectively determined iteratively, by the greatest possible overlapping of particle and circle being selected as iteration criterion. Alternatively, points can also be obtained from the graphic representation and from these points a circle or else an ellipse can be calculated, matching in the best possible manner.

A statistical evaluation then takes place according to the following criteria

LEFT GRAIN
PARAMETER OF THE CIRCLE

| | |
|---|---|
| Centre | (a, b) = (334.674, 333.636) |
| Radius | r = 324.768 |

STATISTICAL INFORMATION CONCERNING THE GRAIN

| | |
|---|---|
| Number of approximated points | n = 1316 |
| Sum of the error squares | Sigma(delta²⁾ = 1.22919e+004 |
| Variance | sigma = Sigma(delta²)/n = |
| | 9.34037e+000 |

DEPTHS OF ROUGHNESS

| | |
|---|---|
| 0° . . . 60° | Rz1 = 12.238 |
| 60° . . . 120° | Rz2 = 10.286 |
| 120° . . . 180° | Rz3 = 8.347 |
| 180° . . . 240° | Rz4 = 7.876 |
| 240° . . . 300° | Rz5 = 8.391 |
| 300° . . . 360° | Rz6 = 4.678 |

Mean depth of roughness Rzm = (Rz1 + . . . Rz6)/6 = 8.636
Mean depth of roughness per circle diameter rel_Rzm = Rzm/(2*r) =
1.32956e−002
AREAS

| | |
|---|---|
| Area of the approximated circle | Aa = 331356.573 |
| Grain size | Ak = 332225.690 |
| Non-overlapping area | Aü = 3487.639 |

AREA RATIOS

| | |
|---|---|
| Non-overlapping area per point | Aü/n = 2.65018e+000 |
| Non-overlapping area per | Aü/Aa = 1.05253e−002 |
| approximated area | |
| Non-overlapping area per grain area | Aü/Ak = 1.04978e−002 |
| Circle area per grain area | Aa/Ak = 9.97384e−001 |

FURTHER DIMENSIONLESS RATIOS

| | |
|---|---|
| sigma/Aa = | 2.81883e−005 |
| sigma/Ak = | 2.81145e−005 |
| sigma/Aü = | 2.67814e−003 |

RIGHT GRAIN
PARAMETER OF THE CIRCLE right

| | |
|---|---|
| Centre | (a, b) = (308.430, 283.887) |
| Radius | r = 280.473 |

STATISTICAL INFORMATION CONCERNING THE GRAIN

| | |
|---|---|
| Number of approximated points | n = 1185 |
| Sum of the error squares | (delta²) = 7.88969e+004 |
| Variance | sigma = Sigma(delta²)/n = |
| | 6.65797e+001 |

DEPTHS OF ROUGHNESS

| | |
|---|---|
| 0° . . . 60° | Rz1 = 7.555 |
| 60° . . . 120° | Rz2 = 7.220 |
| 120° . . . 180° | Rz3 = 4.315 |
| 180° . . . 240° | Rz4 = 11.875 |
| 240° . . . 300° | Rz5 = 17.350 |
| 300° . . . 360° | Rz6 = 22.633 |

Mean depth of roughness Rzm = (Rz1 + . . . Rz6)/6 = 11.825
Mean depth of roughness per circle diameter rel_Rzm = Rzm/(2*r) =
2.10802e−002
AREAS

| | |
|---|---|
| Area of the approximated circle | Aa = 247133.465 |
| Grain area | Ak = 249282.610 |
| Non-overlapping area | Aü = 7155.719 |

AREA RATIOS

| | |
|---|---|
| Non-overlapping area per point | Aü/n = 6.03858e+000 |
| Non-overlapping area per | Aü/Aa = 2.89549e−002 |
| approximated area | |
| Non-overlapping area per grain area | Aü/Ak = 2.87052e−002 |
| Circle area per grain area | Aa/Ak = 9.91379e−001 |

FURTHER DIMENSIONLESS RATIOS

| | |
|---|---|
| sigma/Aa = | 2.69408e−004 |
| sigma/Ak = | 2.67085e−004 |
| sigma/Aü = | 9.30440e−003 |

Here, sigma represents the variance, Rzm the mean depth of roughness, which in this measurement example is obtained from six individual values, rel_Tzm represents the depth of roughness normalized to the circle diameter, Aa the area of the approximated circle, Ak the grain area and Aü the area which does not lie both in the approximated circle and in the grain. It is to be understood that an approximation to an ellipse can also be selected for a more accurate calculation. Instead of this iterative approximation, a statistical evaluation can also take place.

Identical measurements were carried out for the remaining hard particles marked in the figures and compiled in the following table:

| | | | | | | | | |
|---|---|---|---|---|---|---|---|---|
| Sigma | Rzm | rel_Rzm | Au/Aa | Au/Ak | Aa/Ak | sigma/Aa | sigma/Ak | sigma/Au |

FIG. 1

| | | | | | | | | | |
|---|---|---|---|---|---|---|---|---|---|
| Left | 66.5797 | 11.8250 | 0.0211 | 0.0290 | 0.0287 | 0.9914 | 0.0003 | 0.0003 | 0.0093 |
| Right | 9.3404 | 8.6360 | 0.0133 | 0.0105 | 0.0105 | 0.9974 | 0.0000 | 0.0000 | 0.0027 |
| Mean | 37.9600 | 10.2305 | 0.0172 | 0.0197 | 0.0196 | 0.9944 | 0.0001 | 0.0001 | 0.0060 |

FIG. 3

| | | | | | | | | | |
|---|---|---|---|---|---|---|---|---|---|
| | 66.2351 | 10.3140 | 0.0190 | 0.0315 | 0.0314 | 0.9983 | 0.0003 | 0.0003 | 0.0090 |
| | 14.9793 | 8.1020 | 0.0216 | 0.0333 | 0.0332 | 0.9967 | 0.0001 | 0.0001 | 0.0041 |
| Mean | 40.6072 | 9.2080 | 0.0203 | 0.0324 | 0.0323 | 0.9975 | 0.0002 | 0.0002 | 0.0066 |

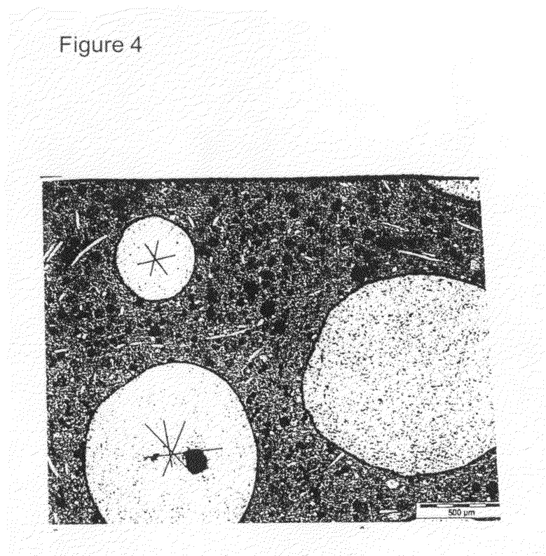

FIG. 4

| | | | | | | | | |
|---|---|---|---|---|---|---|---|---|
| 190.7000 | 17.7320 | 0.0247 | 0.0983 | 0.1073 | 1.0921 | 0.0005 | 0.0005 | 0.0048 |

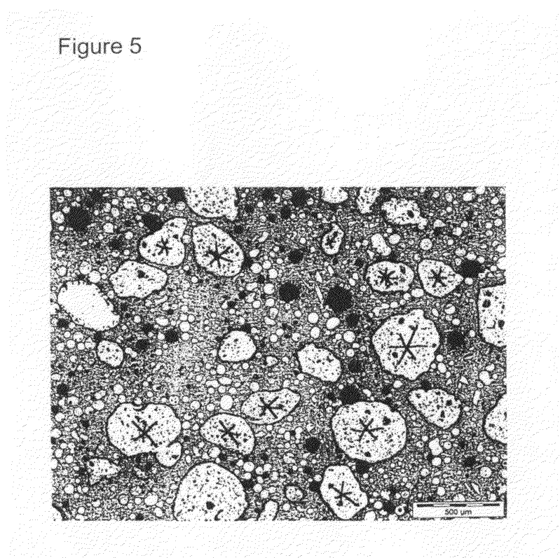

FIG. 5

| | | | | | | | | | |
|---|---|---|---|---|---|---|---|---|---|
| | 239.9490 | 16.1360 | 0.0725 | 0.2493 | 0.2573 | 1.0323 | 0.0062 | 0.0064 | 0.0247 |
| | 112.9960 | 13.0480 | 0.1102 | 0.2924 | 0.3291 | 1.1253 | 0.0103 | 0.0116 | 0.0351 |
| | 146.5050 | 13.7040 | 0.0819 | 0.2900 | 0.2691 | 0.9280 | 0.0067 | 0.0062 | 0.0230 |
| | 111.6460 | 16.9340 | 0.0999 | 0.2118 | 0.2128 | 1.0047 | 0.0049 | 0.0050 | 0.0233 |
| | 73.2181 | 12.9420 | 0.0451 | 0.0879 | 0.0889 | 1.0116 | 0.0011 | 0.0011 | 0.0129 |
| | 105.4980 | 14.5100 | 0.0500 | 0.1304 | 0.1248 | 0.9575 | 0.0016 | 0.0015 | 0.0122 |
| | 183.4440 | 16.2960 | 0.0753 | 0.2226 | 0.2360 | 1.0601 | 0.0050 | 0.0053 | 0.0224 |
| | 370.1570 | 23.4060 | 0.1250 | 0.3674 | 0.3587 | 0.9762 | 0.0134 | 0.0131 | 0.0366 |
| | 283.3440 | 10.8740 | 0.0567 | 0.3146 | 0.3047 | 0.9684 | 0.0098 | 0.0095 | 0.0312 |
| Mean | 180.7508 | 15.3167 | 0.0796 | 0.2407 | 0.2424 | 1.0071 | 0.0066 | 0.0066 | 0.0246 |

FIG. 6

| | | | | | | | | | |
|---|---|---|---|---|---|---|---|---|---|
| | 32.0876 | 11.4970 | 0.0792 | 0.1334 | 0.1346 | 1.0090 | 0.0019 | 0.0020 | 0.0145 |
| | 301.9000 | 13.7530 | 0.0991 | 0.4619 | 0.4359 | 0.9436 | 0.0200 | 0.0188 | 0.0432 |
| | 1488.580 | | | 0.9225 | 1.9697 | 2.1350 | 0.0800 | 0.1709 | 0.0868 |
| | 132.9680 | 19.0910 | 0.0837 | 0.1481 | 0.1514 | 1.0223 | 0.0033 | 0.0033 | 0.0220 |
| | 461.8500 | 18.3550 | 0.1061 | 0.4131 | 0.4233 | 1.0247 | 0.0197 | 0.0201 | 0.0476 |
| | 3358.170 | 34.3190 | 0.1236 | 0.7244 | 1.3333 | 1.8405 | 0.0555 | 0.1021 | 0.0766 |
| | 374.0970 | 25.2000 | 0.1467 | 0.3827 | 0.3911 | 1.0220 | 0.0162 | 0.0165 | 0.0422 |
| Mean | 878.5218 | 20.3692 | 0.1064 | 0.4552 | 0.6913 | 1.2853 | 0.0281 | 0.0477 | 0.0476 |

For the characterization as a ball according to the invention, accordingly the gaps of the relative depth of roughness rel_Rzm or variance by particle area sigma/Ak are examined, so that it becomes clear that the particles in FIG. 6 are not in fact balls.

In accordance with the definition given here for hard balls, it can be seen immediately that the hard particles illustrated in FIG. 6 are not balls.

In a comparison, round, cubic hard particles and hard particles provided with points were examined in their bulk density.

| | Bulk density | Spec. Density | Bulk density |
|---|---|---|---|
| | kg/l | kg/l | index |
| Round | 2.48 | 3.80 | 0.65 |
| Cubic | 2.24 | 3.95 | 0.57 |
| Pointed | 2.04 | 3.95 | 0.52 |
| Mixture | 2.36 | 3.83 | 0.62 |
| 80/20 | | | |
| Mixture | 2.18 | 3.92 | 0.56 |
| 80/20 | | | |

Here the mixture 80/20 consists 80% of round hard particles, whereas the mixture 20/80 has 20% round hard particles and the remaining proportions were formed by the hard particles provided with points. It has been found from this that already small proportions of round hard particles have an extremely favourable effect on the rheological characteristics of the total mixture of a plastic matrix which is still brushable, and hard particles, so that in particular very high densities of hard particles can be achieved.

The measured bulk densities were normalized to determine the respective bulk density index through the specific density.

1. Wear-resistant coating of hard particles in a plastic matrix, wherein at least 10% by vol. of the hard particles are hard balls.

2. Wear-resistant coating according to claim 1, wherein the hard balls are obtained by sintering, a spraying method and/or by melting-on of hard grains.

3. Wear-resistant coating of hard particles in a plastic matrix according to claim 1, wherein at least 10% by vol. of the hard particles have a roundness index greater than 0.05, preferably greater than 0.1, in particular greater than 0.15.

4. Wear-resistant coating of hard particles in a plastic matrix according to claim 1, wherein at least 10% by vol. of the hard particles have a surface roughness less than 15%, preferably less than 12%, in particular less than 10%, of the mean particle diameter.

5. Wear-resistant coating according to claim 1, wherein the proportion is at least 15% by vol.

6. Wear-resistant coating according to claim 5, wherein the proportion is at least 20% by vol.

7. Wear-resistant coating according to claim 6, wherein the proportion is at least 30% by vol.

8. Wear-resistant coating of hard particles in a plastic matrix according to claim 1, wherein the proportion of hard particles in the plastic matrix is over 40% by weight.

9. Wear-resistant coating according to claim 8, wherein the proportion of hard particles in the plastic matrix is over 45% by weight.

10. Wear-resistant coating according to claim 9, wherein the proportion of the hard particles in the plastic matrix is over 50% by weight.

11. Wear-resistant coating according to claim 8, wherein the proportion of the hard particles in the plastic matrix is under 95% by weight.

12. Wear-resistant coating of hard particles in a plastic matrix according to any claim 1, wherein the proportion of the hard particles in the plastic matrix is over 15% by vol.

13. Wear-resistant coating according to claim 12, wherein the proportion of hard particles in the plastic matrix is over 20% by vol.

14. Wear-resistant coating according to claim 13, wherein the proportion of hard particles in the plastic matrix is over 25% by weight.

15. Wear-resistant coating according to claim 12, wherein the proportion of hard particles in the plastic matrix is under 80% by weight.

16. Wear-resistant coating according to claim 1, wherein the bulk density index of the hard particles is greater than 0.54.

17. Wear-resistant coating according to claim 16, wherein the bulk density index is 0.56 or greater.

18. Wear-resistant coating according to claim 1, wherein a dust proportion of hard particles is under 10% by weight of the hard particles.

19. Wear-resistant coating according to claim 1, wherein at least 10% by weight of the hard particles have a diameter greater than 1 μm.

20. Wear-resistant coating according to claim 1, wherein the volume proportion of the hard particles perpendicular to the surface of the wear-resistant coating varies less than 20%, preferably less than 10%.

21. Wear-resistant coating according to claim 1, wherein the thickness of the layer is at least four times as great as the mean grain diameter of the hard particles.

22. Wear-resistant coating according to claim 1, further comprising a layer thickness of over 0.8 mm, preferably of over 1.0 mm or of over 1.2 mm.

23. Wear-resistant coating according to claim 1, wherein the hard particles have a screen sizing of less than 600 μm with a substantially Gaussian distribution.

24. Wear-resistant coating according to claim 23, wherein the screen sizing is less than 150 μm.

25. Wear-resistant coating according to claim 24, wherein the screen sizing is less than 125 μm.

26. Wear-resistant coating according to claim 1, further comprising a mean particle diameter of the hard particles of less than 500 μm.

27. Wear-resistant coating according to claim 26, wherein the mean particle diameters is less than 120 μm.

28. Wear-resistant coating according to claim 27, wherein the mean particle diameters is less than 100 μm.

29. Wear-resistant coating according to claim 1, wherein the hard particles comprise hard metal particles.

30. Wear-resistant coating according to claim 1, wherein the hard particles comprise steel particles.

31. Wear-resistant coating according to claim 1, wherein the hard particles have a Mohs hardness of over 4, preferably over 5.

32. Wear-resistant coating according to claim 1, wherein the plastic matrix has a Shore D hardness below 80 and the hard particles have a Shore D hardness which lies above the Shore D hardness of the plastic matrix.

33. Wear-resistant coating according to claim 1, further comprising a duroplastic plastic matrix.
